(19) United States
(12) Patent Application Publication
(10) Pub. No.: US 2009/0317086 A1
(43) Pub. Date: Dec. 24, 2009

(54) OPTICAL TRANSCEIVER MODULE AND METHOD OF CONTROLLING OPTICAL TRANSCEIVER MODULE

(76) Inventors: Naofumi Morohashi, Yokohama (JP); Futoshi Endou, Yokohama (JP); Shigeru Tokita, Yokohama (JP); Hiroo Matsue, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/109,498

(22) Filed: Apr. 25, 2008

(30) Foreign Application Priority Data
Sep. 10, 2007 (JP) 2007-234139

(51) Int. Cl. H04B 10/00

(52) U.S. Cl. 398/135

(57) ABSTRACT

An optical transceiver module for transmitting and receiving an optical signal with a plurality of channels includes timing generator for sequentially generating timing instructions defining different start-up time points, and powering controller for effecting a control such that power supply to at least a portion of circuit components associated with the respective channels is sequentially started in accordance with the timing instructions generated by the timing generator. Current to be instantaneously necessitated when a power switch is turned on or when a power restoration is made from power saving operation modes can be suppressed.

### INCORPORATION BY REFERENCE

The present invention claims priority from Japanese application JP 2007-234,139 filed on Sep. 10, 2007, the content of which is hereby incorporated by reference into the this application.

### BACKGROUND OF THE INVENTION

1. Field of the Invention

The present invention relates to optical transceiver modules, methods of controlling an optical transceiver module, and control programs therefor. More particularly, the present invention relates to technologies for controlling boot timing for respective channels in a multi-channel optical transceiver module capable of transmitting and receiving optical signals with a plurality of channels.

2. Description of the Related Art

One of the problems encountered with the optical transmitting apparatuses is to make compatible an increase of transmission data amount and a decrease of sizes of the apparatus. As a technique for increasing transmission data amount, the WDM (Wavelength Division Multiplexing) is known in which data transmission is performed through the multiplexing of a plurality of optical channels of different wavelengths.

Recently, multi-channel optical transceiver modules conforming to 10GBASE-LX 4 standards have been put on the market, in which a transmission rate as high as 10 Gbps is realized with a single module employing the WDM for multiplexing four optical channels of wavelengths of the order of 1310 nm. (See, for example, IEEE 802.3ae 53. Physical Medium Dependent (PMD) sublayer and baseband medium, type 10GBASE-LX4). With such optical transceiver modules, it will be possible to solve the above-mentioned problem and to simplify connection of optical fibers.

### SUMMARY OF THE INVENTION

However, in the conventional multi-channel optical transceiver modules of the type mentioned above in which a plurality of optical semiconductor devices are packaged into a single module, when a power switch is turned on or when a restoration to a normal powering operation mode is made from a power saving operation mode (a low power mode or a shutdown mode), all of the channels will be simultaneously booted to instantaneously increase current consumption with a result that the power source voltage for the module may be abruptly dropped.

Particularly, in multi-channel optical modules having a high transmission rate in which it is difficult to suppress current consumption in each individual channel, it is highly possible that such power source voltage drops may cause malfunctions in the module.

An object of the present invention is to provide an optical transceiver module capable of suppressing electric current to be instantaneously necessitated at such a time as when a power switch is turned on or when a restoration is made to a normal powering operation mode from a power saving operation mode.

Another object of the present invention is to provide a method of controlling an optical transceiver module.

Another object of the present invention is to provide a control program for an optical transceiver module.

According to one aspect of the present invention, an optical transceiver module for transmitting and receiving an optical signal with a plurality of channels includes timing generating means for sequentially generating timing instructions defining different start-up time points, and powering controlling means for effecting a control such that power supply to at least a portion of circuit components associated with the respective channels is sequentially started in accordance with the timing instructions generated by the timing generating means.

According to the above aspect of the present invention, since the time points of start of power supply to at least a portion of circuit components associated with the respective channels are different from one channel to another, current to be instantaneously necessitated when the channels are booted or started up can be suppressed.

According to another aspect of the present invention, the timing generating means includes timer means for measuring time lengths so that the timing instructions are generated based on the time lengths measured by the timer means. According to this aspect of the present invention, the channels can be booted at different time points reached after different time lapses from a predetermined time point.

According to another aspect of the present invention, the timing generating means includes voltage monitoring means for monitoring a power source voltage for the module so that the timing instructions are generated based on results of the monitoring by the voltage monitoring means. According to this aspect of the present invention, the channels can be sequentially booted at different time points depending on the degree of variations of the power source voltage for the module.

According to another aspect of the present invention, generation of the timing instructions by the timing generating means is started at the time of restoration to a normal powering operation mode from a power saving operation mode. According to this aspect of the present invention, current to be instantaneously necessitated at the restoration to a normal powering operation mode from a power saving operation mode can be effectively suppressed.

According to another aspect of the present invention, generation of the timing instructions by the timing generating means is started at the time when a power switch for the module is turned on. According to this aspect of the present invention, current to be instantaneously necessitated when a power switch is turned on can be effectively suppressed.

According to another aspect of the present invention, a method of controlling an optical transceiver module for transmitting and receiving an optical signal with a plurality of channels includes a timing generation step of sequentially generating timing instructions defining different start-up time points, and a powering step of sequentially starting, in accordance with the timing instructions generated in the timing generation step, power supply to at least a portion of circuit components associated with the respective channels.

According to another aspect of the present invention, a control program is for an optical transceiver module for transmitting and receiving an optical signal with a plurality of channels, the program being for making a computer function as timing generating means for sequentially generating timing instructions defining different start-up time points, and for making the computer function as means for causing powering controlling means to sequentially start, in accordance with the timing instructions generated by the timing generating means, power supply to at least a portion of circuit components associated with the respective channels.

The above-mentioned program may be stored in a computer-readable information storage medium, which may be magnetic tapes, flexible disks, hard disks, CD-ROMs, magneto-optical (MO) disks, mini-disks (MD), DVD-ROMs, IC cards and so forth.

According to the above aspects of the present invention, current to be instantaneously necessitated at such a time as when a power switch is turned on or when a restoration to a normal powering operation mode is made from a power saving operation mode can be effectively suppressed to thereby prevent malfunctions due to voltage drops, with a result that each of the plural channels is stably booted.

Other objects, features and advantages of the present invention will become apparent from the following description of the embodiments of the invention taken in conjunction with the accompanying drawings.

### BRIEF DESCRIPTION OF THE DRAWINGS

FIG. 1 is a block diagram of an optical transceiver module according to an embodiment of the present invention.

FIG. 2 is a diagram illustrating an example of power supply start timing in an optical transceiver module and an example of a waveform of the power source voltage at the time of a power restoration in the optical transceiver module, in an embodiment of the present invention.

FIG. 3 is a flowchart showing a power restoration process in an optical transceiver module from a shutdown mode according to an embodiment of the present invention.

FIG. 4 is a diagram illustrating an example of power supply start timing and an example of a waveform of the power source voltage at the time of a power restoration in the conventional optical transceiver module.

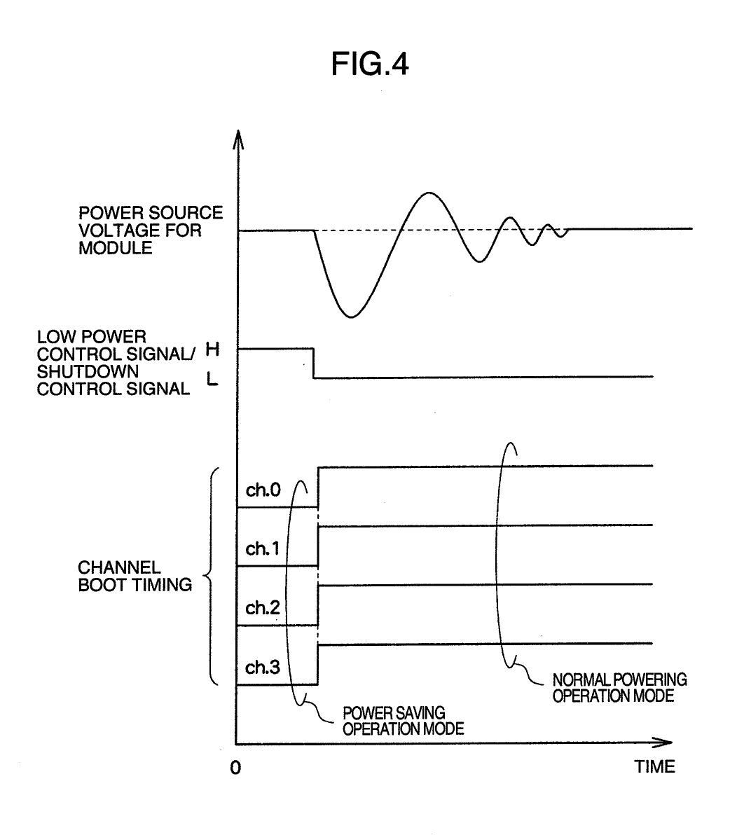

### DESCRIPTION OF THE EMBODIMENTS

Embodiments of the present invention will now be described in detail with reference to the accompanying drawings.

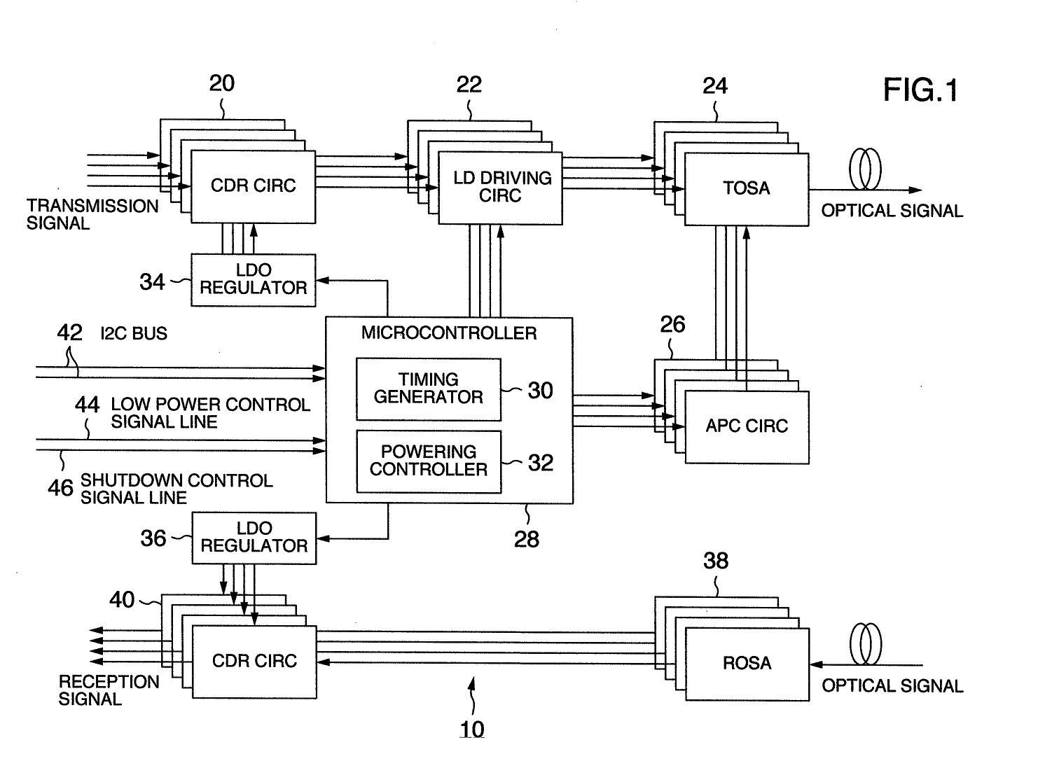

FIG. 1 is a block diagram of an optical transceiver module 10 according to an embodiment of the present invention. The optical transceiver module 10 is a multi-channel optical transceiver module such as a QSFP (Quad Small Form-Factor Pluggable) module, a 10 GBASE-LX4 module or a 10 GBASE-X40 module. It is assumed here that four channels are multiplexed in the optical transceiver module 10.

As shown in the drawing, the module 10 includes, for each of the four channels to be multiplexed, one CDR (Clock Data Recovery) circuit 20, one CDR circuit 40, one LD (Laser Diode) driving circuit 22, one TOSA (Transmitter Optical Sub-Assembly) device 24, one APC (Automatic Power Control) circuit 26 and one ROSA (Receiver Optical Sub-Assembly) device 38, and further includes a microcontroller 28, an LDO (Low Dropout Voltage) regulator 34 and an LDO regulator 36.

The CDR circuits 20 are operative with power supplied from the LDO regulator 34 to recover clock information from an electrical signal received from a transmitting apparatus on which the module is mounted and to wave-shape the received electrical signal based on the recovered clock information.

The LD driving circuits 22 supply a modulation current, which varies in accordance with the wave-shaped electrical signal inputted from the CDR circuits 20, to the TOSA devices 24 to thereby directly modulate an optical signal to be outputted from the TOSA devices 24.

The APC circuits 26 control a bias current to be supplied to the TOSA devices 24 so that the optical output therefrom is kept constant.

The TOSA devices 24 deliver an optical signal directly modulated with the bias current supplied from the APC circuits 26 and the modulation current supplied from the LD driving circuits 22. In a shutdown mode to be described later, power supply from the APC circuits 26 and the LD driving circuits 22 is stopped, and the optical output from the TOSA devices 24 is accordingly ceased.

The ROSA devices 38 receive an optical signal transmitted from another transmitting apparatus and convert it to an electrical signal for supply to the CDR circuits 40.

The CDR circuits 40 are operative with power supplied from the LDO regulator 36 to wave-shape the electrical signal received from the ROSA devices 38 and to deliver the wave-shaped electrical signal to the transmitting apparatus on which the module 10 is mounted.

The microcontroller 28 includes a CPU, a memory (a ROM or an EEPROM) for storing therein programs and a timer and controls the respective parts in the optical transceiver module 10. Particularly, the microcontroller 28 serves to control the operation modes of the module 10 in accordance with control signals applied thereto from the transmitting apparatus through a low power control signal line 44 or a shutdown control signal line 46.

The operation modes under control of the microcontroller 28 include, in addition to the normal powering operation mode, two power saving operation modes (i.e., a low power mode and a shutdown mode).

The normal powering operation mode is a mode in which, upon a turn-on of a power switch for the optical transceiver module 10 or upon power a restoration from any one of the power saving operation modes, all of the circuit components associated with the respective four channels are supplied with power. In this operation mode, booting of all of the four channels has been completed to make communications with all of the channels available.

The low power mode is a mode in which powering by all of the LD driving circuits 22, the APC circuits 26 and LDO regulators 34 and 36 is stopped to collectively cease power supply to the CDR circuits 20 and 40, TOSA devices 24 and others for all of the four channels. This mode saves power more than the shutdown mode to be described later.

Switching between the normal powering operation mode and the low power mode is carried out by a low power control signal applied through a low power control signal line 44. More particularly, when the level of voltage on the line 44 is changed from low (“L”, hereafter) to high (“HI”, hereafter), the microcontroller 28 causes all of the LD driving circuits 22, the APC circuits 26 and LDO regulators 34 and 36 to stop their power supply operations. Conversely, when the voltage level of the line 44 is changed from H to L, the power supply operations are resumed from the low power mode state.

The shutdown mode is a mode in which powering of the TOSA devices 24 by the LD driving circuits 22 and the APC circuits 26 is stopped channel by channel to disable an optical output from a portion or all of the TOSA devices 24.

Switching between the normal powering operation mode and the shutdown mode is carried out by a shutdown control signal applied through a shutdown control signal line 46. More particularly, when the level of voltage on the line 46 is changed from L to high H, the microcontroller 28 causes the LD driving circuits 22 and the APC circuits 26 associated with a portion or all of the channels to stop their power supply operations. Conversely, when the voltage level of the line 46 is changed from H to L, the power supply operations of the LD driving circuits 22 and the APC circuits 26 are resumed so that the optical transceiver module 10 is restored to the normal powering operation mode from the shutdown mode.

Next, the timing with which power supply to the respective circuit components is started at such a time as when a power switch is tuned on or when a restoration to a normal powering operation mode is made from power saving operation mode will be described in detail.

The microcontroller 28 includes, as constituent function blocks, a timing generator 30 and a powering controller 32 both for controlling timing with which to start power supply to the respective circuit components of the optical transceiver module 10. These functions are realized by the CPU executing various programs stored in the memory.

The timing generator 30 sequentially generates, based on time information generated by the timer capable of measuring time lengths, timing instructions defining different start-up time points. The generation of timing instructions is started when a power switch for the optical transceiver module 10 is turned on or when a restoration to the normal powering operation mode is made from the power saving operation modes. As for the time lengths to be measured by the timer, they may be lapses of time from a time point at which the power switch is turned on or may be time periods between a booting of one channel and that of the next following channel.

The powering controller 32 controls, depending on the operation modes, powering operations of the LD driving circuits 22, the APC circuits 26 and the LDO regulators 34 and 36 so that power supply to at least a portion of the circuit components associated with the respective four channels is sequentially started in accordance with the timing instructions, defining different start-up time points, generated by the timing generator 30.

More particularly, when the power switch for the optical transceiver module 10 is turned on, power supply is sequentially started, with different timing i.e., at different start-up time points defined by the timing instructions generated by the timing generator 30) for individual channels, to all of the circuit components associated with the respective channels. When a restoration to the normal powering operation mode is made from the low power mode, powering by the LD driving circuits 22, the APC circuits 26 and the LDO regulators 34 and 36 associated with the respective channels is sequentially started with different timing for individual channels. When a restoration to the normal powering operation mode is made from the shutdown mode, powering by the LD driving circuits 22 and the APC circuits 26 associated with the respective channels is sequentially started with different timing for individual channels.

Furthermore, when the LDO regulators 34 and 36 are not capable of controlling power supply to the CDR circuits 20 and 40, respectively, channel by channel, additional devices may be employed for controlling powering for individual channels.

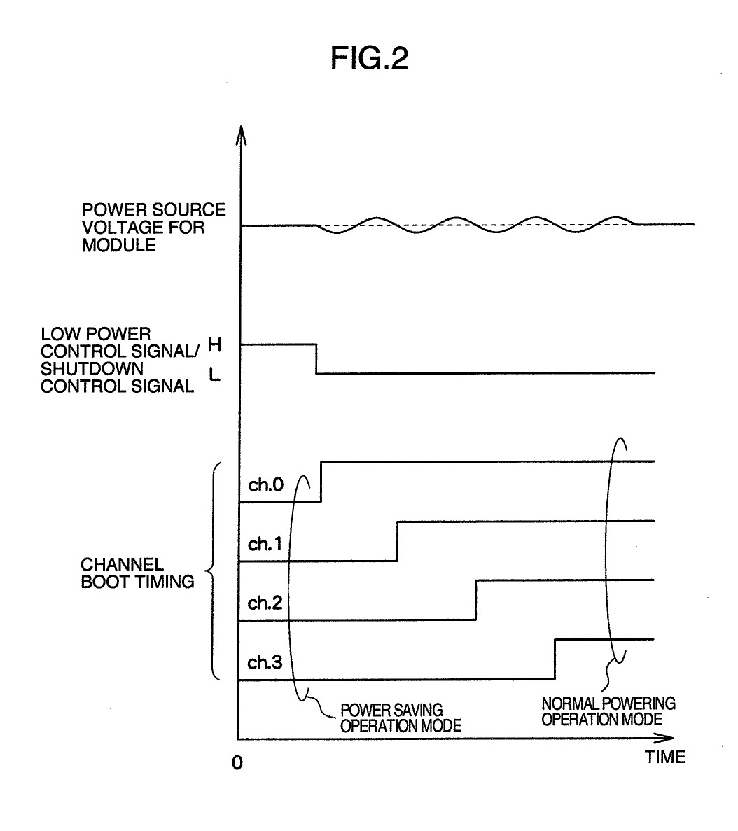

FIG. 2 is a diagram illustrating an example of power supply start timing in an optical transceiver module 10 and an example of a waveform of the power source voltage at the time of a power restoration in the optical transceiver module, in an embodiment of the present invention.

With the low power control signal (or with the shutdown control signal) inputted from the transmitting apparatus for instructing a restoration to the normal powering operation mode as shown in the drawing, the timing generator 30 sequentially generates four timing instruction signals for the respective channels ch0 to ch3, defining different start-up time points determined from a time point at which the voltage level of the low power control signal line 44 or the shutdown control signal line 46) is changed from H to L. Then, the powering controller 32 sequentially starts to supply power, for the respective four channels, to at least a portion of their associated circuit components in accordance with the timing instruction signals generated by the timing generator 30. Thus, as shown in FIG. 2, electric current instantaneously necessitated at such a time as when the power switch for the module is turned on or when a restoration to the normal powering operation mode is made from the power saving operation modes is suppressed which leads to suppression of drops of the module power source voltage and to suppression of possible subsequent variations in the module power source voltage.

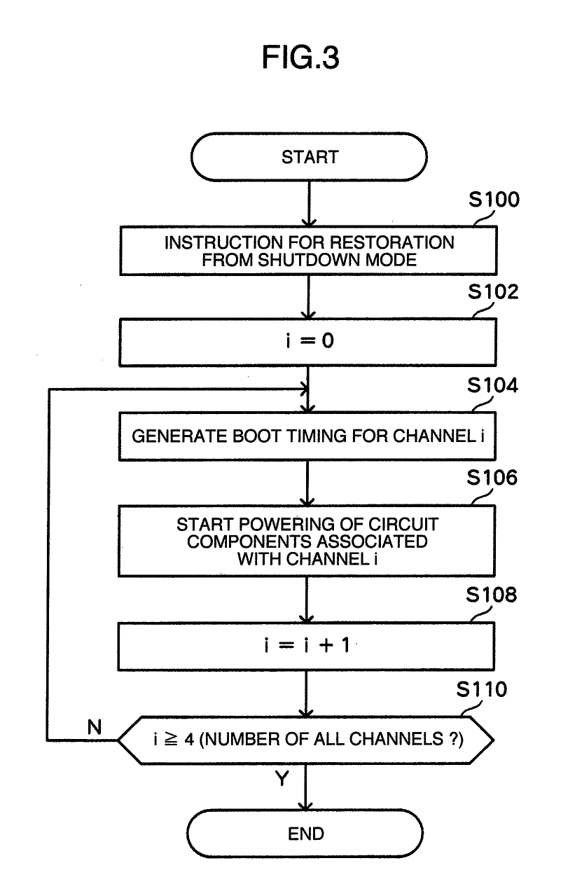

An example of an operation of the optical transceiver module 10 will now be described. FIG. 3 is a flowchart showing a power restoration process from a shutdown mode in an optical transceiver module 10 according to an embodiment of the present invention.

As shown in the drawing, when the transmission apparatus issues an instruction for a restoration to the normal powering operation mode to the optical transceiver module 10 under the shutdown mode of operation (S100), that is, when the voltage level of the shutdown control signal line 46 is changed from H to L, the timing generator 30 initializes a counter i representative of a channel to be booted to 0 (zero) (S102).

Next, the timing generator 30 generates boot timing instruction for the i-th channel (channel i, hereafter), based on a time length measured by the timer (S104). For example, the boot timing for channel 0 may be determined as at a time point immediately after a change of the voltage level of the shutdown control signal line 46 from H to L, and those for the rest channels may be determined in such a manner that the boot timing for one channel is at a time point a predetermined time length after the booting of the immediately preceding channel.

Subsequently, the powering controller 32 causes, in accordance with the timing instructions generated by the timing generator 30, the LD driving circuit 22 and the PC circuit 26 associated with channel i to power the associated TOSA device 24 (S106), and increments the counter i by one (S108).

The optical transceiver module 10 repetitively executes the step S104 and the subsequent steps until booting of all channels has been completed, i.e., until the count of the counter i becomes not smaller than the number of all channels (four, in this embodiment). The process comes to an end when all channels have been booted (S110).

As has been described above, according to the embodiments, when the power switch for the optical transceiver module is turned on or when a restoration is made to the normal powering operation mode from the power saving operation modes, power supply is sequentially started, with different timing for individual channels, to at least a portion of circuit components associated with the respective channels. Therefore, current to be instantaneously necessitated at the time of the turn-on of the power switch or of the restoration to the normal powering operation mode is effectively suppressed. Thereby, malfunctions of the module owing to voltage drops can be avoided to ensure individual stable booting of each of the plural channels.

It should be noted that the present invention is not limited to the above-described embodiments, and various modified embodiments are possible. For example, although in the above embodiments, the timing generator 30 sequentially generates timing instructions defining different start-up time points based on time lengths measured by the timer, the timing generator 30 may include a voltage monitor for monitoring the power source voltage for the module 10 so that the timing instructions defining different start-up time points are sequentially generated based on results of the monitoring by the voltage monitor. In such a modified embodiment, for example, by sequentially generating timing instructions defining different start-up time points each time the degree or amount of variations of the voltage monitored by the monitor goes down a predetermined value, it will be possible to appropriately suppress voltage drops without resort to any timer means such as a timer.

Furthermore, in the above embodiments, the low power control signal (or shutdown control signal) is supplied to the module 10 through the low power control signal line 44 (or shutdown control signal line 46), but the signal may be supplied through an I2C (Inter-Integrated Circuit) bus 42 or through another control signal line.

Furthermore, in the above embodiments, use is made of the microcontroller 28 (including the timing generator 30 and the powering controller 32) to control the power supply start timing, but any power monitoring device having functions equivalent to those of the timing generator 30 and the powering controller 32 may instead be employed to control the power supply start timing.

It should be further understood by those skilled in the art that the foregoing description has been made on embodiments of the invention and that various changes and modifications may be made in the invention without departing from the spirit of the invention and the scope of the appended claims.

1. An optical transceiver module for transmitting and receiving an optical signal with a plurality of channels comprising:
timing generating means for sequentially generating timing instructions defining different start-up time points; and
powering controlling means for effecting a control such that power supply to at least a portion of circuit components associated with the respective channels is sequentially started in accordance with said timing instructions generated by said timing generating means.

2. An optical transceiver module according to claim 1, wherein said timing generating means includes timer means for measuring time lengths so that said timing instructions are generated based on the time lengths measured by said timer means.

3. An optical transceiver module according to claim 1, wherein said timing generating means includes voltage monitoring means for monitoring a power source voltage for the module so that said timing instructions are generated based on results of monitoring by said voltage monitoring means.

4. An optical transceiver module according to claim 1, wherein generation of said timing instructions by said timing generating means is started upon a restoration to a normal powering operation mode from a power saving operation mode.

5. An optical transceiver module according to claim 1, wherein generation of said timing instructions by said timing generating means is started when a power switch for the module is turned on.

6. A method of controlling an optical transceiver module for transmitting and receiving an optical signal with a plurality of channels comprising:
a timing generation step of sequentially generating timing instructions defining different start-up time points; and
a powering step of sequentially starting, in accordance with said timing instructions generated in said timing generation step, power supply to at least a portion of circuit components associated with the respective channels.

7. A computer readable medium storing therein a control program for an optical transceiver module for transmitting and receiving an optical signal with a plurality of channels, said control program being for making a computer function as timing generating means for sequentially generating timing instructions defining different start-up time points, and for making the computer function as means for causing powering controlling means to sequentially start, in accordance with said timing instructions generated by said timing generating means, power supply to at least a portion of circuit components associated with the respective channels.
